(19) United States
(12) Patent Application Publication
(10) Pub. No.: US 2025/0078114 A1
(43) Pub. Date: Mar. 6, 2025

(54) GENERATING EXPERIMENT METRIC VALUES FOR ANYTIME VALID EXPERIMENTATION

(71) Applicant: Adobe Inc., San Jose, CA (US)

(72) Inventors: David ARBOUR, San Jose, CA (US); Ziao LIU, San Francisco, CA (US); Ritwik SINHA, Cupertino, CA (US); Akash MAHARAJ, Stanford, CA (US)

(21) Appl. No.: 18/460,076

(22) Filed: Sep. 1, 2023

(51) Int. Cl. G06Q 30/0242

(52) U.S. Cl. CPC G06Q 30/0243; G06Q 30/0201

(57) ABSTRACT

Embodiments of the present technology are directed to facilitating generation of experiment metric values, such as expected sample size and/or minimal detectable effect, for anytime valid confidence sequences (e.g., asymptotic confidence sequences). In one embodiment, a set of parameter values associated with an experiment using asymptotic confidence sequences are obtained. The set of parameter values include a minimal detectable effect and an uncertainty interval. Thereafter, an expected sample size for executing the experiment is determined based on the minimal detectable effect and the uncertainty interval. The expected sample size is provided for utilization in association with the experiment using asymptotic confidence sequences.

### BACKGROUND

In determining whether there is a statistical distinction between a given option (e.g., an existing website design) and an alternative option (e.g., a new website design) randomized A/B hypothesis testing can be utilized. For example, consider an online retailer that is trying to determine which of two layouts for a website provides for more completed transactions, or a higher dollar amount for each transaction. In A/B hypothesis testing the two layouts are randomly distributed equally to visitors of the online retailer's site. Then the visitors' interactions with each layout can be monitored for feedback such as, whether the visitor made a purchase or an amount of each visitors purchase. Based on this feedback one of the two designs that exhibits better performance can be selected via A/B hypothesis testing. One manner of implementing A/B hypothesis testing is through a fixed-horizon configuration. When using a fixed-horizon configuration, however, a total amount of feedback needed to conclude the test is determined prior to implementing the A/B hypothesis test.

### SUMMARY

Embodiments of the present invention are directed at generating and/or providing experiment metric values for anytime valid experimentation. In particular, given a different way to measure uncertainty using anytime valid confidence sequences, as opposed to a fixed-horizon configuration, embodiments described herein enable experiment metric values to be generated for anytime valid confidence sequences and, in particular, asymptotic confidence sequences. To this end, experiment metric values, such as expected sample size and/or minimal detectable effect, are generated in an efficient and effective manner for anytime valid experimentation (e.g., asymptotic confidence sequences). Advantageously, such experiment metrics are determined for anytime valid experimentation (e.g., asymptotic confidence sequences), such that an experiment can be executed with the benefits provided via an anytime valid confidence sequences experiment while also providing and/or utilizing valuable data provided via the experiment metrics (e.g., in advance of or concurrently with executing an experiment). For example, an expected sample size can be used as guidance for how long to run an experiment or determining when to terminate an experiment.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts aspects of an illustrative network environment suitable for use in implementing embodiments described in accordance with the present disclosure.

FIG. 2 depicts an illustrative implementation for facilitating generation of experiment metrics for anytime valid experimentation, in accordance with various embodiments of the present disclosure.

FIG. 3 illustrates a process flow depicting an example for generating experiment metrics, in accordance with various embodiments of the present disclosure.

FIG. 4 illustrates another process flow depicting an example for generating experiment metrics, in accordance with various embodiments of the present disclosure.

FIG. 5 illustrates another process flow depicting an example for generating experiment metrics, in accordance with various embodiments of the present disclosure.

FIG. 6 is a block diagram of an example computing device in which embodiments of the present disclosure may be employed.

### DETAILED DESCRIPTION

A commonly presented issue in practical business analysis is trying to determine which of two options provide a better result with regard to a given population. An example of this issue is trying to determine which of two different web page designs, or other digital content design, provide better results, such as number of clicks generated, with regard to visitors of an associated website. To determine which of the two options provide better results with the given population, a process called A/B testing is often relied on. In A/B testing, there is generally a control, or null, option represented by ‘A,’ and an alternative option represented by ‘B.’ In A/B testing, one of two hypotheses (e.g., null hypothesis or alternative hypothesis) is sought to be confirmed. These two hypotheses include a null hypothesis, commonly referred to as Ho, and an alternative hypothesis, commonly referred to as H₁. The null hypothesis proposes that the effects of A and B are equal; that is there is no significant difference between A and B. The alternative hypothesis, on the other hand, proposes that the effects of A and B are not equal, that is, there is a significant difference between option A and option B. As used in this context, a significant difference is one that is not attributable to sampling or experimental error.

In order to confirm either the null hypothesis or the alternative hypothesis, options A and B are apportioned (e.g., equally) to members of the given population and feedback, or samples, are collected concerning an observable effect of the two options. This feedback can then be utilized to determine whether the effect of A is equal to B (i.e., affirm the null hypothesis) or whether the effect of A is not equal to B (i.e., reject the null hypothesis). As an example, consider a website having a current design (i.e., the control option) and a new design (i.e., the alternative option). To affirm whether an effect of the current design is equal to, or different from, an effect of the new design, the current design and the new design can be automatically apportioned among users visiting the website and feedback can be collected by monitoring the interaction between the users and the two designs. This feedback could be any type of feedback that the test designer views as important in determining a difference between the current design and the alternative design (e.g., number of clicks). By analyzing this feedback, it can be confirmed whether option A elicited more clicks, or fewer clicks, than option B, or whether option A elicited the same number of clicks as option B.

One aspect of A/B testing is identifying when a test can be declared to have completed such that the results of the test are statistically sound. Determining when a test can be declared to have completed is important in several aspects. For example, test termination may be desired as the collection and processing of the feedback can be computationally intensive. Further, it may be desired to advance implementation of one of the options. For instance, in accordance with completing a test, a winner (e.g., the better performing option, if there is one) can be declared, thereby enabling the better performing option to be implemented.

In determining whether the completion of a test can be considered statistically sound, two types of errors are commonly considered. The first type of error is referred to as a type I error and is commonly represented by ‘α.’ A type I error occurs in instances where a difference between the effects of A and the effects of B is declared when there is actually no difference between the two options (e.g., option A is erroneously declared to perform better than option B). A common measurement for type I error is referred to as confidence level, which is represented by the equation: 1—type I error (i.e., 1-α). The second type of error is considered a type II error and is commonly represented by ‘0.’ A type II error occurs in instances where the effect of option A and the effect of option B are different, but the two options are erroneously declared to be equal (e.g., option A is erroneously declared to be equal to option B). A common measurement for type II error is referred to as power, or statistical power, which is represented by the equation: 1—type II error (i.e., 1-β). A goal in A/B testing is to identify when a test can be declared to have completed such that the type I error, or confidence level, and/or the type II error, or power, are within a determined range of acceptability (e.g., confidence level of 0.95, or 95%, and power of 0.8, or 80%). To expand on this, at a confidence level of 95%, results of the test can be declared to be 95% assured that a winner among the options is not erroneously declared (e.g., option A is declared to be a winner when there is actually no significant difference between option A and option B). In contrast, at a power of 80%, results of the test can be declared to be 80% assured that no significant difference between the options is erroneously declared (e.g., option A and option B are declared to have no significant difference, when there is actually a winner).

A common way of performing A/B testing, in a manner that maintains control of type I and type II errors, is referred to as fixed-horizon hypothesis testing. Fixed-horizon hypothesis testing utilizes a sample size calculator that takes as input a desired confidence level, a desired power, a baseline statistic for the base option (e.g., click through rate), and a minimum detectable effect (MDE). Based on these inputs, the sample size calculator outputs a horizon, ‘N.’ The horizon, ‘N,’ represents the amount of feedback, or number of samples, to be collected for each of the base option and alternative option in order to achieve the desired confidence level and desired power. Returning to the previous example, if the base option is a current design for a website, the alternative option is a new design for the website, and the sample size calculator calculates that the horizon N=1000, then the current design would be presented 1000 times, the new design would be presented 1000 times, and corresponding feedback would be collected. This feedback can be analyzed to determine whether to reject the null hypothesis, Ho, or accept it. In fixed-horizon multiple hypothesis testing, the test is run until the total number of samples has been collected. Once the total number of samples has been collected, a p-value can be computed for each of the hypothesis tests. Such a p-value can represent the probability of observing a more extreme test statistic in the direction of the alternative hypothesis for the respective hypothesis test.

Once the p-values are computed for the fixed-horizon multiple hypothesis tests, then various algorithms that take the p-values as input and determine which of the multiple hypothesis tests should be rejected (i.e., which of the respective null hypothesis should be rejected) can be utilized. These algorithms include, for example, Bonferroni, Holm, and Hochberg algorithms for FWER, and Benjamin-Hochberg for FDR. Generally, if the p-value is relatively small, then the null hypothesis is rejected in favor of the alternative hypothesis. If the p-value is relatively large, then the null hypothesis is not rejected. In this regard, the p-value (or confidence interval) can be compared to an appropriate threshold only when the pre-identified sample size is reached.

Fixed-horizon hypothesis testing, however, has several drawbacks. A first drawback of fixed-horizon hypothesis testing is that it is oftentimes desirable for the tester (e.g., the person implementing the test) to be able to view results of the test as the feedback is collected and analyzed. As a result, in some instances, the tester may prematurely stop a fixed-horizon hypothesis test upon erroneously confirming or rejecting the null hypothesis based on observed feedback. By stopping the test early, the tester has circumvented the guarantees provided by the fixed-horizon hypothesis test with respect to the desired confidence level and desired power and, as such, the experimentation may be deemed to have no value. This drawback is commonly referred to as the peeking problem. Generally, peeking or early stopping can result in inflation of type I error in such fixed-horizon implementations. Further, performing comparisons multiple times before reaching the sample size or collecting more data and performing additional comparisons drastically inflates the type I error. Another drawback is that the fixed horizon, N, is based at least in part on estimates for the baseline statistic and MDE, which may not be accurate and may be difficult for an inexperienced tester to accurately estimate.

Another form of A/B testing includes anytime valid confidence sequences (ACS) for analyzing results of an A/B test. With ACS, instead of a measured value being valid only at the end of the experimentation, measured values are valid at any time during the experimentation. ACS provides anytime valid guarantee on the type I error of a hypothesis text. For example, for a pre-specified type I error rate of 5%, ACS provides confidence bounds such that the probability at any time of a type I error is less than or equal to 5%. Unlike fixed-horizon hypothesis testing, ACS testing does not utilize a fixed amount of feedback or samples to determine when the test can be stopped. In this way, ACS is in contrast to fixed-horizon hypothesis test, which requires the total sample size to be pre-specified prior to the beginning of the experiment and provide a confidence interval which adheres to a desired type I error rate conditional on the entire experiment completing without any intermediate calculations of the confidence interval.

As such, ACS testing enables flexibility in performing testing, for example, such as monitoring testing and/or terminating testing at any time while controlling type I error. However, while a pre-specified sample size is not needed for ACS, a target sample size is often valuable to assess the expected number of samples or observations that will be necessary in order to detect an effect in an A/B test. In this way, a notion of a target sample size is useful for planning, deployment, and interpretation of experiments. It also enables maintaining backward compatibility on the experience of an A/B tester. In the ACS experiment environment, fixed horizon power calculations are not applicable as ACS uses a mixture of Gaussian distributions, rather than a single Gaussian.

Accordingly, embodiments described herein are directed to generating experiment metric values for anytime valid experimentation, such as ACS. In particular, given a different way to measure uncertainty using ACS, embodiments described herein enable experiment metric values to be generated for ACS and, in particular, asymptotic confidence sequences. To this end, experiment metric values, such as expected sample size and/or minimal detectable effect, are generated in an efficient and effective manner for anytime valid experimentation (e.g., asymptotic confidence sequences). As described herein, an expected sample size that represents a target size of samples for executing an experiment is generated given a desired minimal detectable effect and an uncertainty interval (e.g., including an estimated outcome variance). An expected sample size provides a user, such as a tester, a target number of samples to utilize in executing the experiment in order to measure an effect of interest and/or declare a result statistically significant in an ACS experiment. Stated differently, the expected sample size allows for estimating a number of samples in order to determine an experiment is conclusive if there is an effect size greater than some user-defined level. A minimal detectable effect that represents a smallest improvement or effect size that an experiment can detect with a certain probability and significance level. A minimal detectable effect is generated given a desired sample size and an estimated outcome variance. Advantageously, such experiment metrics are determined for anytime valid experimentation (e.g., asymptotic confidence sequences), such that an experiment can be executed with the benefits provided via an ACS experiment while also providing and/or utilizing valuable data provided via the experiment metrics (e.g., in advance of or concurrently with executing an experiment). For example, an expected sample size can be used as guidance for how long to run an experiment or determining when to terminate an experiment.

Advantageously, identification of experiment metric values in association with an ACS experiment enables more efficient use of computing resources. As one example, an experiment can be terminated in accordance with an estimated sample size generated based on a desired minimal detectable effect such that computing resources are limited in utilization or conserved (e.g., clock cycles, memory, etc.) by performing the experiment for only the expected number samples that need to be collected to achieve a desired minimal detectable effect. Further, experiment metric values can be determined during execution of the experiment such that the metric values can be updated based on observed data, thereby reducing the potential unnecessary use of computing resources (e.g., used to continue observing samples). As such, embodiments described herein reduce unnecessary use of computing resources as experiments are not run longer than needed or executed without enough information.

Various terms or phrases are used herein to describe various aspects of the technology. Although generally described in further detail herein, below is a brief description of some of these terms or phrases:

An asymptotic confidence sequences generally enable continuous monitoring of experiment outcomes while maintaining an analogous 1-α type I guarantee. Confidence sequences are generally sequences of confidence intervals that are uniformly valid over time. In this way, asymptotic confidence sequences can be referred to as time-uniform analogues of asymptotic confidence intervals.

A minimal detectable effect generally refers to a value that represents a smallest improvement or effect size that an experiment can detect with a certain probability and significance level. In embodiments, a minimal detectable effect is generated given a desired sample size and an uncertainty interval (e.g., using an estimated outcome variance).

An expected sample size generally refers to a target size or number of samples to utilize in executing an experiment in order to measure an effect of interest and/or to declare a result statistically significant in an experiment (ACS experiment). The expected sample size allows for estimating a number of samples in order to determine an experiment is conclusive if there is an effect size greater than some user-defined level.

An uncertainty interval generally refers to a range of values that represents uncertainty in a measure or prediction. An uncertainty interval includes an interval or value range within which a true value of the quantity being measured is expected within a particular level (e.g., percent, such as 95%) of confidence. In one example, and as shown more fully below, an uncertainty interval can be determined using a standard deviation, a time (sample number), a quantile, and an optimization parameter.

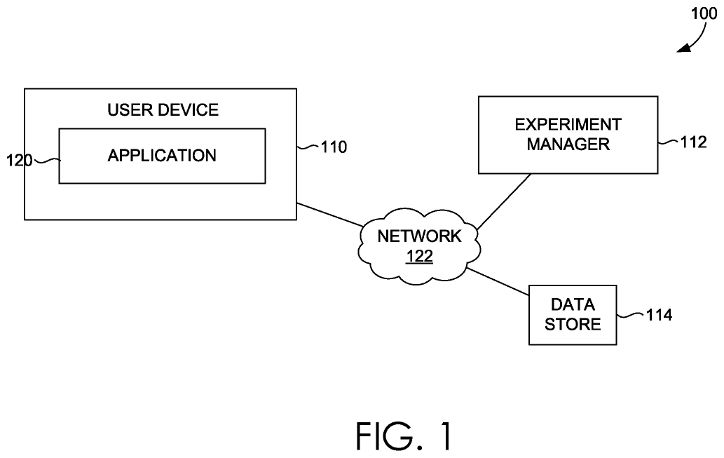

Referring initially to FIG. 1, a block diagram of an exemplary network environment 100 suitable for use in implementing embodiments described herein is shown. Generally, the system 100 illustrates an environment suitable for facilitating generating and/or providing experiment metrics for anytime valid experimentation in an effective and efficient manner. Among other things, embodiments described herein enable automatic generation of experiment metrics for anytime valid experimentation. In particular, for an anytime valid experimentation, various metrics, such as an expected sample size and/or minimal detectable effect, are generated in an automated manner. As described, an anytime valid experimentation generally refers to an experimentation or test that enables continuous monitoring of an A/B test and data-dependent stopping. One example of an anytime valid experimentation in which embodiments described herein can be employed is anytime valid confidence sequences (ACS). In embodiments, an anytime valid confidence sequence is in the form of a asymptotic confidence sequence, as described more fully herein.

To do so, various parameter values are referenced and used to generate or determine various experiment metrics, such as expected sample size and/or minimal detectable effect. The experiment metrics can then be provided for display to a user (e.g., a tester) and/or implemented in association with an experimentation. For example, an experiment can be generated that includes one or more experiment metrics. In this way, an experiment can be executed in association with an expected sample size and/or minimal detectable effect such that the experiment is executed in an efficient and effective manner. Advantageously, using implementations described herein enables efficient and effective generation of experiment metrics, such as expected sample size and/or minimal detectable effect, in an automated manner, thereby reducing unnecessary utilization of computing resources and increasing efficiency of computing resources. For example, using an appropriate expected sample size to execute an anytime valid experiment can reduce unnecessary utilization of computing resources that may come with terminating an experiment too early, that is, without enough samples, or continuing an experiment that could be discontinued (e.g., an adequate result is achieved).

The network environment 100 includes a user device 110, an experiment manager 112, and a data store 114. The user device 110, the experiment manager 112, and the data store 114 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the user device 110 may be in communication with the experiment manager 112 via a mobile network or the Internet, and the user device 110 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another, for example, at least a portion of the data store 114 may be integrated with the user device 110.

As described, a user device, such as user device 110, facilitates automated generation of experiment metrics for anytime valid experimentation in an effective and efficient manner. Automated generation of experiment metrics, such as expected sample size for a corresponding experiment, enables a more efficient and more accurate process for implementing an experiment, thereby providing a more desirable implementation and output to the user (e.g., a designer).

User device 110 can be a client device on a client-side of operating environment 100, while experiment manager 112 can be on a server-side of operating environment 100. Experiment manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and/or experiment manager 112 to remain as separate entities.

In an embodiment, the user device 110 is separate and distinct from the experiment manager 112 and the data store 114. In another embodiment, the user device 110 is integrated with one or more illustrated components. For instance, the user device 110 may incorporate functionality described in relation to the experiment manager 112 and/or data store 114. For clarity of explanation, embodiments are described herein in which the user device 110, the experiment manager 112, and the data store 114 are separate, while understanding that this may not be the case in various configurations contemplated.

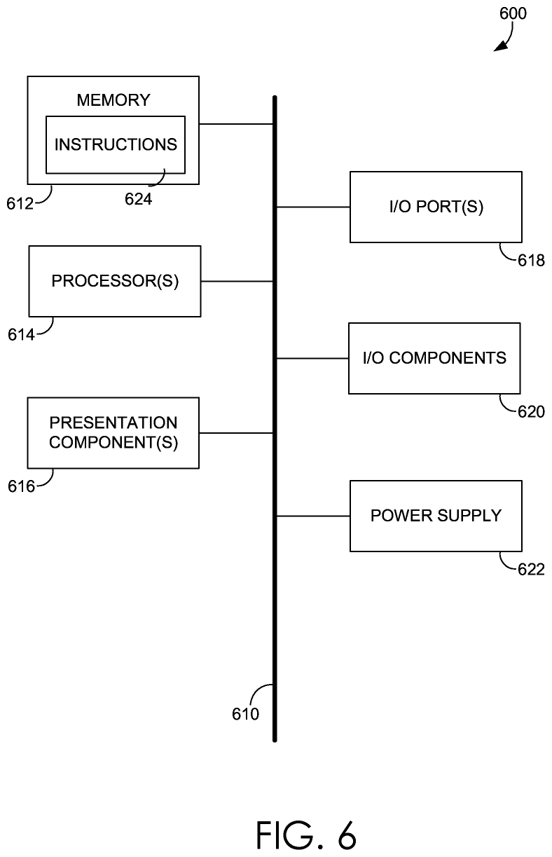

The user device 110 can be any kind of computing device capable of facilitating automated generation of experiment metrics for anytime valid experimentation. For example, in an embodiment, the user device 110 can be a computing device such as computing device 600, as described above with reference to FIG. 6. In embodiments, the user device 110 can be a personal computer (PC), a laptop computer, a workstation, a mobile computing device, a PDA, a cell phone, or the like. In embodiments, the user device 110 includes a display screen on which a user interface may be displayed to support user interaction. In some implementations, the user device 110 includes the display screen. That is, a display screen is integrated or coupled with the user device. In other implementations, a display screen is remote from, but in communication with, the user device. The display screen is a screen or monitor that can visually present, display, or output information, such as text (e.g., an indication of an expected sample size or minimal detectable effect).

The user device can include one or more processors, and one or more computer-readable media. The computer-readable media may include computer-readable instructions executable by one or more processors. The instructions may be embodied by one or more applications, such as application 120 shown in FIG. 1. The application(s) may generally be any application capable of facilitating automated generation of experiment metrics for anytime valid experimentation. In embodiments, the application may be an analysis application that includes functionality to prepare and/or perform anytime valid experimentations and/or analyze results thereof. In particular, an analysis application may be used to input parameter values in association with an anytime valid experiment and, in response to obtaining parameter values, automatically identify or generate experiment metrics for use in executing or performing the experiment.

In some implementations, the application(s) comprises a mobile application or a web application, which can run in a web browser, and could be hosted at least partially server-side (e.g., via experiment manager 112). In addition, or instead, the application(s) can comprise a dedicated application or a stand-alone application. In some cases, the application is integrated into the operating system (e.g., as a service). In some cases, the functionality described herein may be integrated directly with an application or may be an add-on, or plug-in, to an application. Example of applications that may be used to manage generation, design, and/or execution of anytime valid experimentation include Adobe® Journey Optimizer and Adobe® Experience Platform.

A user device 110 and/or application 120 is generally operated by an individual (e.g., an experimenter or tester) or entity interested in generating and/or executing an experiment, such as an anytime valid experimentation (e.g., ACS). The user device 110 and/or application 120 may accept and process user inputs, such as parameter values. A user, for example, may provide inputs or edits using a selector/cursor control device, touch, gesture, stylus, and so on to design and/or initiate execution of an experimentation. In some cases, an experiment design be initiated at the user device 110. For example, in some cases, a user may input parameter values associated with an experiment. Parameter values may be input in any number of ways, including use of text, selection of parameter values (e.g., via a menu, etc.).

The user device 110 and/or application 120 can communicate with the experiment manager 112 to initiate and/or execute automated generation of experiment metrics for an anytime valid experimentation. In embodiments, for example, a user may utilize the user device 110 to initiate automated generation of experiment metrics for anytime valid experimentation via the network 122. For instance, in some embodiments, the network 122 might be the Internet, and the user device 110 and/or application 120 interacts with the experiment manager 112 to initiate automated generation of experiment metrics. In other embodiments, for example, the network 122 might be an enterprise network associated with an organization. In yet other embodiments, the experiment manager 112 may additionally or alternatively operate locally on the user device 110 to perform functionality at the user device. For example, the experiment manager 112 may be incorporated as a tool or functionality performed via the application 120. It should be apparent to those having skill in the relevant arts that any number of other implementation scenarios may be possible as well.

As such, the experiment manager 112 can be implemented in any number of ways. For example, the experiment manager 112 can be implemented as a tool that executes within application 120. In this regard, the experiment manager 112 might operate at the user device to provide local functionality. As another example, the experiment manager 112 can be implemented as server systems, program modules, virtual machines, components of a server or servers, networks, and the like. In this way, such an experiment manager 112 may communicate with application 120 operating on user device 110 to provide back-end services to application 120.

At a high level, the experiment manager 112 manages anytime valid experimentations. In embodiments, the experiment manager 112 manages generating experiment metric values for anytime valid experimentations. In this regard, the experiment manager 112 can facilitate generation of an expected sample size and/or minimal detectable effect for a particular anytime valid experimentation, such as ACS (e.g., asymptotic confidence sequences). To do so, the experiment manager 112 can obtain various parameter values associated with an experimentation. The parameter values can then be used to generate experiment metrics, such as expected sample size and/or minimal detectable effect. Such experiment metric values can be provided, for example, to the user device 110 for display to the user. For example, in some cases, a user may input parameter values and, in response be provided with an expected sample size and/or minimal detectable effect for use in performing an experiment. In other cases, a user may select to view experiment metric values for a particular experiment and, in response, be presented with an expected sample size and/or minimal detectable effect. In some embodiments, the generated experiment metric values may be included in an experiment design and/or implemented in an experiment. For example, in some cases, upon determining an experiment metric value, such as expected sample size, the experiment metric value can be included (e.g., automatically or upon a user selection) in an experiment design and implemented (e.g., automatically or upon a user selection) in execution of the experiment. For example, the expected sample size can be used to carry out the experiment such that the experiment is not terminated with too few samples or unnecessary abundance of samples. Advantageously, the experiment metrics can be used to implement the experiment in an efficient and effective manner, thereby reducing unnecessary utilization of computing resources and increasing efficiency of computing resources.

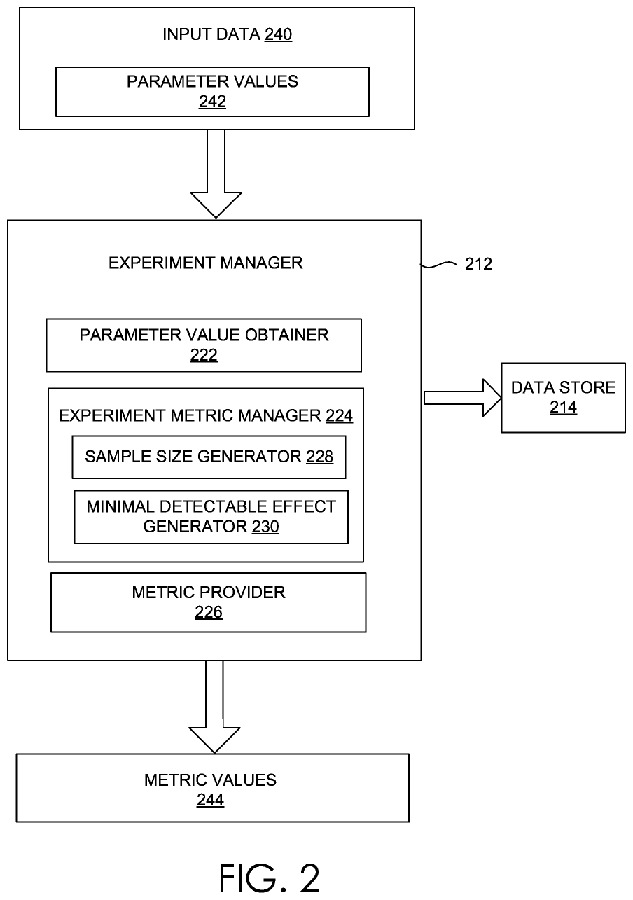

Turning now to FIG. 2, FIG. 2 illustrates an example implementation for facilitating generation of experiment metrics for anytime valid experimentation, in accordance with embodiments described herein. The experiment manager 212 can communicate with the data store 214. The data store 214 is configured to store various types of information, such as parameter values and/or experiment metric values, accessible by the experiment manager 212 or other component. In embodiments, user devices (such as user device 110 of FIG. 1) and/or experiment manager 212 can provide data that is stored in the data store 214, which may be retrieved or referenced by any such component.

As described herein, a parameter value generally refers to a value associated with a parameter of a function or problem (e.g., optimization problem). An experiment metric value, as used herein, generally refers to a value, measure, or extent associated with a metric, such as an expected sample size metric or a minimal detectable effect metric. In this regard, experiment metric value may be an expected sample size (e.g., a number of samples) or a minimal detectable effect (e.g., size of effect that can be detected).

In operation, the experiment manager 212 is generally configured to facilitate generation of experiment metric values for anytime valid experimentation in an effective and efficient manner, in accordance with embodiments described herein. As described, an anytime valid experimentation includes an anytime valid confidence sequence, such as an asymptotic confidence sequence. In accordance with a design of an anytime valid experimentation, an experiment metric(s) value(s) associated with the experiment is generated via the experiment manager 212. In this way, an expected sample size and/or minimal detectable effect can be determined and utilized to effectively and efficiently execute the experiment.

In embodiments, the experiment manager 212 includes a parameter value obtainer 222, an experiment metric manager 224, and a metric provider 226. According to embodiments described herein, the experiment manager 212 can include any number of other components not illustrated. In some embodiments, one or more of the illustrated components 222, 224, and 226 can be integrated into a single component or can be divided into a number of different components. Components 222, 224, and 226 can be implemented on any number of machines and can be integrated, as desired, with any number of other functionalities or services. As described herein, the experiment manager 212, or portion thereof, may reside locally at a user device. For example, the experiment manager 212 may be incorporated as part of an analytics application that is used to analyze data, such as content design, marketing data, etc.

The parameter value obtainer 222 is generally configured to manage parameter values associated with experimentations, such as anytime valid experimentations (e.g., ACS). In this regard, parameter value obtainer can obtain input data 240 including a set of parameter values 242. Various parameters for which parameter values can be obtained may be an empirical mean, an uncertainty interval, a null hypothesis mean, an alternative hypothesis mean, a total number of samples, a type 1 error, a type II error, a variance, a standard deviation, a quantile, an optimization parameter, a sample size, and/or the like.

An empirical mean generally refers to an empirical mean at time t. In this regard, empirical mean can reflect an average associated with an experiment. An approximation of the empirical mean can be generated based on results from previous or historical experiments for power estimation.

An uncertainty interval generally refers to a range of values that represents uncertainty in a measure or prediction. An uncertainty interval includes an interval or value range within which a true value of the quantity being measured is expected within a particular level (e.g., percent, such as 95%) of confidence. In one example, and as shown more fully below, an uncertainty interval can be determined using a standard deviation, a time (sample number), a quantile, and an optimization parameter.

A null hypothesis mean generally refers to a mean associated with the null hypothesis. In embodiments, the null hypothesis mean is set to or established to be a value of zero. An alternative hypothesis mean generally refers to a mean associated with the alternative hypothesis. In embodiments, the alternative hypothesis mean is set to or established to be a value representing a minimal detectable effect. As described, a minimal detectable effect generally refers to a smallest improvement or effect size that an experiment can detect with a certain probability and significance level. As one example, via a user interface, a user may select or input a desired minimal detectable effect, such that the minimal detectable effect can be used to generate an expected sample size. For instance, a minimal detectable effect of 5% (e.g., needed to justify a particular design) may be input for use in identifying an expected sample size.

A total number of samples T generally refers to a total number of samples to be considered in an experiment. For example, a total number of samples may be represented by a total population size. In some cases, T may not be specified. In such cases, T may be set of a large number (e.g., a multiplier of a sample size such as a user base). A time t generally refers to a particular number of samples/observations. In embodiments, the time t refers to a desired sample size to use for an experiment (e.g., input via a user).

A type I error rate, sometimes also referred to as an alpha level or significance level, generally refers to a probability of rejecting the null hypothesis given that it is true. A type II error rate generally refers to a probability of failing to reject a null hypothesis when it is fails.

A variance generally refers to a measure of how data points differ from a mean. In other words, variance refers to a spread in metric, or how far a set of data are spread out from their mean value. Variance generally depends on the standard deviation of a given data set. Variance provides an actual value to how much the numbers in a dataset vary from a mean. A standard deviation generally refers to variation in data and indicates how far apart numbers are in a dataset. If the data is close together, the standard deviation is smaller than if the data is spread out. The standard deviation is generally calculated as the square root of variance by determining each data point's deviation relative to the mean. Standard deviation can be user estimated and specified and/or based on historical data. As one example, in cases in which an outcome of interest has been measured, the variance of such data can be measured and used.

A quantile generally refers to cut points dividing the range of a probability distribution into continuous intervals with equal probabilities, or dividing the observations in a sample. In some cases, a type I error denotes the quantile of the Normal distribution that is being used as a threshold for type I error.

An optimization parameter generally refers to a tuning parameter which dictates the time at which is the asymptotic confidence sequence is the tightest. Stated differently, the optimization parameter is a parameter that optimizes a boundary condition. A boundary condition generally refers to a condition specified for a solution to a set of differential equations. Generally, an asymptotic confidence sequence, as described in more detail below, includes an additional parameter p, which optimizes the boundary condition, F. In embodiments, the optimization parameter is in the form of a hyper parameter. The optimization parameter may change when the estimate is as tight as possible to a theoretical expected width. A smaller optimization parameter will take longer to get as tight as possible.

In some cases, such an optimization parameter may be user specified, or a default value, for example. In other cases, an optimization parameter may be automatically generated or determined. In this regard, the parameter value obtainer 222, or other component, can automatically optimize the hyper parameter of ACS, which can thereafter be used to determine experiment metrics, such as expected sample size and/or minimal detectable effect. An optimization parameter may be determined in any of a number of ways. In one embodiment, for a target sample size t, the value of p which optimizes the boundary is provided as the following optimization problem:

$${min}_{ρ > 0} {Γ}_{{t}^{*}} = \sqrt{\frac{- {W}_{- 1} ( {α}^{2} exp \{ {α}^{2} = \} - 1 )}{{t}^{*}}}$$

where W₋₁ is the lower branch of the Lambert function W. An approximation using a Taylor expansion with negligible empirical differences to the exact solution is as follows:

$${ρ}^{2} ( {t}^{*} ) := \frac{( {α}^{2} - 2 log α + log ( - 2 log α + 1 - {α}^{2} )}{{t}^{*}}$$

Considering the approximate solution given, the reliance on the experimenter can be removed to specify ρ by inserting its value into Γ, giving a closed form as follows:

$${Γ}_{t}^{*} = \sqrt{\hat{v} {ar}_{t} ( \hat{f} )} \cdot \sqrt{\frac{2 ( ( - {α}^{2} - 2 log α + log ( - 2 log α + 1 - {α}^{2} ) ) + 1 )}{t ( - {α}^{2} - 2 log α + log ( - 2 log α + 1 - {α}^{2} )} log \frac{\sqrt{( - {α}^{2} - 2 log α + log ( - 2 log α + 1 - {α}^{2} ) ) + 1}}{α}}$$

In some cases, an optimization parameter may be determined in accordance with proposing a t value in association with identifying the expected sample size. As such, for a t value proposed in association with determining the expected sample size, corresponding parameter values can be used in association with the closed form described above to obtain a new optimization parameter value, which can then be used to determine the expected sample size.

As can be appreciated, such parameter values may be obtained in any of a number of ways. In some examples, parameter values are accessed from a data store. For example, for an experiment, including a null hypothesis and an alternative hypothesis, a set of parameter values may be stored and, as such, the parameter values can be accessed from the data store. Parameter values may be stored in a data store based on previous experiments, user input, default values, automatic determination, etc. Alternatively or additionally, parameter values can be obtained based on user input. For example, a user may access a user interface and enter, select, or input various parameter values, as desired. Further, in some cases, parameter values are determined (e.g., optimization parameter).

In embodiments, the parameter values, or a portion thereof, obtained are associated with a particular experiment. For example, a first set of parameter values may be obtained for a first experiment, and a second set of parameter values may be obtained for a second experiment. A particular experiment may be defined or represented using a null hypothesis and an alternative hypothesis. In this regard, a user may input or specify a null hypothesis and/or alternative hypothesis (e.g., via a user interface). An experiment, and/or hypothesis, can be associated with any type of data. As an example, a null hypothesis and alternative hypothesis could represent variations of digital content designs. As used herein, digital content can refer to any content utilized to convey information to a user in an online or digital setting. Digital content designs can include website designs, designs of online marketing material (e.g., advertisements), designs of graphical user interfaces for online applications (e.g., smartphone applications or web applications, etc.), or components of any of these. As an example, a null hypothesis could be a current online marketing design and the alternative hypothesis could represent an alternative online marketing design. In such an example, the aspect being compared could be the number of clicks each design receives, the number of conversions (e.g., purchases of products and/or services, completion of surveys, etc.) each design receives, etc. It will be appreciated that examples provided herein are not exhaustive and are merely meant to be illustrative in nature. Experiments may be associated with other data and are not limited to digital content designs.

The experiment metric manager 224 is generally configured to manage generation of experiment metric values associated with experiment metrics. As described, experiment metrics may include expected sample size and/or minimal detectable effect. As such, the experiment metric manager may include a sample size generator 228 and a minimal detectable effect generator 230. Generally, the experiment metric manager 224 can access obtained parameter values to determine or generate experiment metric values for an experiment metric(s), such as expected sample size and/or minimal detectable effect.

The sample size generator 228 is generally configured to generate or determine expected sample sizes for experiments. In particular, an expected sample size is generated based on a desired minimal detectable effect and an uncertainty interval (e.g. including an estimated variance of outcome, \hat{σ}ₜ). As described, an expected sample size generally refers to a sample size, or number of samples or observations, expected to detect an effect size greater than a user desired minimum effect size given an estimate of outcome variance under ACS. In this way, an expected sample size indicates how many observations or samples are need in order to be certain enough that there is a true effect. Stated differently, an expected sample size refers to an earliest stopping time or minimal number of samples such that the probability of rejecting the null hypothesis is at least By way of example, assume a small amount of data is collected and the standard deviation is very wide, resulting in a large uncertainty. Over time, the uncertainty will become smaller. The expected sample size is the first time the uncertainty interval has reduced enough, for a given mean, such that it is past the 95% if the effect had been 0, such that the expected sample size is the number of observation needed to be certain enough to reflect a true effect.

In one embodiment, given a type 1 error rate of α and a type 2 error rate of β, the expected sample size can be represented as follows:

$${inf}_{t} ( p ( \vert {\hat{μ}}_{t} \vert > \vert {C}_{t}^{- {H}_{0}} ‖ {H}_{1} ) \geq 1 - β )$$

Here, \hat{μ}t represents an empirical or sample mean at time t, t represents a time or sample number, H₁ represents an alternative hypothesis, T represents a total number of samples to consider for an experiment (e.g., total sample size), and Cₜ^{-H}^{₀} represents asymptotic confidence sequence at time t for the null hypothesis, H₀ (e.g., if the null hypothesis is true). In this way, this reflects the probability that this observed value, or empirical value, is greater than the asymptotic confidence sequence under the null hypothesis and that the asymptotic confidence sequence under the null hypothesis is greater than an edge of confidence sequence given the null hypothesis. If the alternative hypothesis is actually true and uncertainty interval is centered at zero, as more data is collected, this maintains the observed mean is greater than one minus type II error for a set number of times. For example, assume 100 samples. In such a case, at least 80 of those samples should have a value greater than the confidence threshold.

In embodiments, the asymptotic confidence sequence at time t for the null hypothesis, Cₜ^{-H}^{₀}, can be determined using a function representing an asymptotic confidence sequence. For example, assume (Ψₜ)ₜ₌₁^{∞}˜ [symbol] is an infinite sequence of independent and identically [symbol] distributed observations from a distribution [symbol] with mean μ and q>2 finite absolute moments. Further, let \hat{μ}ₜ:=1/tΣᵢ₌₁^{t}ψᵢ be the sample mean, and \hat{σ}ₜ²:=1/tΣᵢ₌₁^{t}Ψᵢ²−(\hat{μ}ₜ)² the sample variance based on the first t observations. For a prespecified constant optimization parameter p, the asymptotic confidence sequence can be represented:

$${\overline{C}}_{t} ≡ ( {\hat{μ}}_{t} \pm {t}_{} := ( {\hat{μ}}_{t} \pm {\hat{σ}}_{t} \sqrt{\frac{2 ( t {ρ}^{2} + 1 )}{{t}^{2} {ρ}^{2}} log ( \frac{\sqrt{t {ρ}^{2} + 1}}{α} )} )$$

In this regard, for any prespecified constant ρ>0, the above equation forms a (1−α) asymptotic confidence sequence for μ. Specific to experiments, Ψ is a transformed outcome, e.g., Ψ=−1ᵢ^{a}Yᵢ for equiprobable treatments, and y as the average treatment effect, μₜ=1/tτᵢ^{t}aᵢyᵢ−(1−aᵢ)yᵢ. In this function representing asymptotic confidence sequence, \hat{μ}ₜ represents an empirical or sample mean at time t, t represents a time or sample number, \hat{σ}ₜ represents the standard deviation at time t, α represents the quantile, and p represents an optimization parameter.

As a is the same for both the null and alternative hypothesis and the earliest possible time period is entailed by the time at which the β quantile under H₁ is greater than or equal to the 1−α quantile under H₀, the expected sample size can also be represented as the optimization problem:

$${min}_{t ∈ 1 , … , T} ( \vert {C}_{t}^{- {H}_{0}} \vert - ( {μ}_{{H}_{1}} - {t}_{β , σ}^{} ) \geq 0 )$$

Generally, such an optimization problem reduces to finding the expected sample size, or time t, at which the quantile entailed by the power constraint, β exceeds the decision boundary given by the false discovery rate, α. In this optimization problem, Cₜ^{-H}^{₀} represents the asymptotic confidence sequence at time t for the null hypothesis, which, as described above, can be determined using a representation of an asymptotic confidence sequence. μ_{H}_{₁}, represents the mean under the alternative hypothesis. Generally, this parameter is set to the desired minimal detectable effect (e.g., as input by a user via a user interface). [symbol] ₜ^{α,σ} represents an uncertainty interval, where α represents the type I error (e.g., denoting a quantile) and σ represents the standard deviation. In embodiments, the standard deviation is known a priori. The uncertainty interval, [symbol] ₜ^{α,σ}, is described above in relation to the asymptotic confidence sequence as:

$${σ}_{t} \sqrt{\frac{2 ( t {ρ}^{2} + 1 )}{{t}^{2} {ρ}^{2}} log ( \frac{\sqrt{t {ρ}^{2} + 1}}{α} )}$$

In some embodiments, to determine the expected sample size, various determinations or calculations are performed upon obtaining parameter values. For example, in some cases, various parameter values may be obtained and used to determine an uncertainty interval(s) and/or an asymptotic confidence sequence(s), which can then be used to determine an expected sample size.

Such an optimization problem can be solved in any of a number of ways. In one embodiment, the optimization problem can be efficiently solved using root finding procedures. In this way, the sample size generator 228 can search over t until a value is identified that is rejected. Stated differently, searching over t can be performed until the optimization problem statement is true. As can be appreciated, the times to search for can be selected in any number of ways, including, for example, random selection, increasing value order, decreasing value order, etc. In some implementations, various parameter values are fixed. For instance, the optimization problem can be solved with root finding procedures in accordance with a fixed estimate of standard deviation, a fixed optimization parameter value, a fixed quantile value, a fixed mean under the null hypothesis, and a fixed mean under the alternative hypothesis (e.g., a desired minimal detectable effect).

The minimal detectable effect generator 230 is generally configured to generate or determine minimal detectable effects for experiments, such as ACS experimentation. In particular, a minimal detectable effect is generated based on a desired number of samples and an uncertainty interval (e.g., using an estimated variance of outcome, or estimate of outcome variance). As described, a minimal detectable effect generally refers to a smallest improvement or effect size that an experiment can detect with a certain probability and significance level. As one example, via a user interface, a user may select or input a desired minimal detectable effect, such that the minimal detectable effect can be used to generate an expected sample size. For instance, a minimal detectable effect of 5% may be input for use in identifying an expected sample size.

In one embodiment, given a desired number of samples, a minimum detectable effect may be determined using the following optimization problem:

$${min}_{( ( {μ}_{{H}_{1 )}} \geq 0 )} ( \vert {C}_{t}^{- {H}_{0}} \vert - ( {μ}_{{H}_{1}} - {t}_{β , σ}^{} ) \geq 0 )$$

In this optimization problem, Cₜ^{-H}^{₀} represents the asymptotic confidence sequence at time t for the null hypothesis, which, as described above, can be determined using a representation of an asymptotic confidence sequence. μH₁ represents the mean under the alternative hypothesis. This parameter generally represents the minimum detectable effect being determined. [symbol] ₜ^{α,σ} represents an uncertainty interval, where α represents the type I error (e.g., denoting a quantile) and σ represents the standard deviation. In embodiments, the standard deviation is known a priori. The uncertainty interval, [symbol] ₜ^{α,σ}, is described above in relation to the asymptotic confidence sequence.

In some embodiments, to determine the minimal detectable effect, various determinations or calculations are performed upon obtaining parameter values. For example, in some cases, various parameter values may be obtained and used to determine an uncertainty interval(s) and/or an asymptotic confidence sequence(s), which can then be used to determine a minimal detectable effect.

Such an optimization problem can be solved in any of a number of ways. In one embodiment, the optimization problem can be efficiently solved with root finding procedures. In particular, as the minimal detectable effect optimization problem is monotonic with respect to the mean and, as a result, convex, such an optimization problem can be solved using a root finding procedure. In this way, the minimal detectable effect generator 230 can search over minimal detectable effects until the statement in the minimal detectable effect optimization problem is true. As can be appreciated, the minimal detectable effects to search for can be selected in any number of ways, including, for example, random selection, increasing value order, decreasing value order, etc. In some implementations, various parameter values are fixed. For instance, the optimization problem can be solved with root finding procedures in accordance with a fixed estimate of standard deviation, a fixed optimization parameter value, a fixed quantile value, a fixed mean under the null hypothesis, and a desired number of samples.

The metric provider 226, or other component, can output or provide metric values 244. Metric values may be values associated with any number or type of experiment metrics. For example, metric values 240 may include values associated with expected sample size and/or minimal detectable effect. In some embodiments, metric values are provided for display. For example, metric values may be provided to a user device for display to a user (e.g., experimenter). In this way, a user can view the metric values and use such metric values to design the experiment, implement the experiment, analyze the experiment, and/or the like. Such experiment metrics can be used as guidance as opposed to a criteria for experimentation. For example, assume a metric value indicates an expected sample size of 10,000 samples for an experiment, but when 10,000 samples are collected the analysis can be performed again to recognize that an additional set of samples (e.g., 500 samples) may be advantageous, such that the experiment can continue running or be set to run for the additional set of samples.

Alternatively or additionally, the metric values can be automatically utilized, for example, in an experiment design, in an experiment implementation, and/or in experiment analysis. For example, upon determining an expected sample size, the expected sample size can be automatically implemented in the experiment such that the experiment is executed until it reaches the expected sample size.

As can be appreciated, in some cases, embodiments described herein may be employed in advance of executing an experiment. For example, an experiment (e.g., marketer) may input parameter values in advance of running an experiment as a way to size the experiment to estimate how long it will take to run. Additionally or alternatively, embodiments may be employed during execution of the experiment. For instance, during an experiment, values obtained from a point or time during the experiment can be used to identify or estimate noise associated with the experiment. Such an estimate can be used, for instance, to determine how much longer to run an experiment, assuming the observed effect.

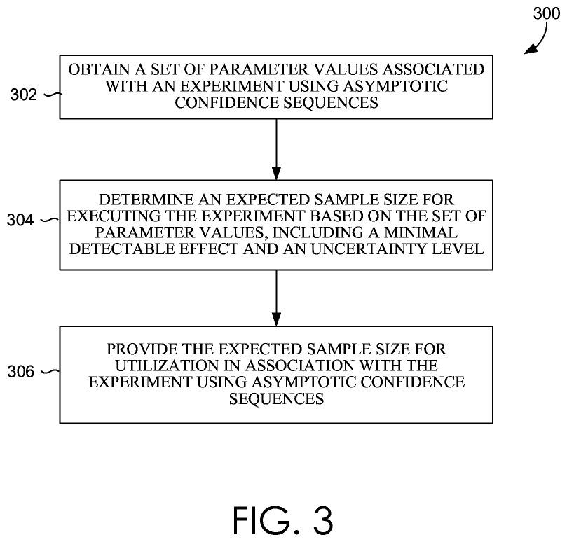

As described, various implementations can be used in accordance with embodiments described herein. FIGS. 3-5 provide methods of facilitating generation of experiment metrics, in accordance with embodiments described herein. The methods 300, 400, and 500 can be performed by a computer device, such as device 600 described below. The flow diagrams represented in FIGS. 3-5 are intended to be exemplary in nature and not limiting. For example, flow diagrams represented in FIGS. 3-5 represent various approaches used to facilitate automated generation of experiment metrics, but are not intended to reflect all combination of technologies and approaches that may be used in accordance with embodiments described herein.

With respect to FIG. 3, FIG. 3 provides one example method flow 300 for generating experiment metrics, in accordance with embodiments described herein. Initially, in method flow 300, at block 302, a set of parameter values associated with an experiment using asymptotic confidence sequences is obtained. The asymptotic confidence sequences can maintain a one minus type I guarantee during continuous monitoring of experiment outcomes. In embodiments, the set of parameter values includes a minimal detectable effect and an uncertainty interval. The minimal detectable effect generally represents a smallest effect size that the experiment can detect with a certain probability and significance level. The minimal detectable effect can be obtained based on a user input specifying the minimal detectable effect. In embodiments, the uncertainty interval uncertainty interval is determined using a quantile parameter value, a standard deviation parameter value, and an optimization parameter value. The optimization parameter value is determined to optimize a boundary condition. The set of parameter values may include values for other parameters, such as an empirical mean, a null hypothesis mean, and a total number of samples.

At block 304, an expected sample size for executing the experiment is determined based on the minimal detectable effect and the uncertainty interval. In embodiments, the expected sample size is determined via an optimization problem using the minimal detectable effect, the uncertainty level, and a confidence sequence associated with a null hypothesis at a time. In some cases, a root finding procedure is used to solve for the optimization problem.

At block 306, the expected sample size is provided for utilization in association with the experiment using asymptotic confidence sequences. In one embodiment, providing the expected sample size for utilization includes causing display of the expected sample size via a user interface. In another embodiment, providing the expected sample size for utilization includes employing the expected sample size in conducting the experiment.

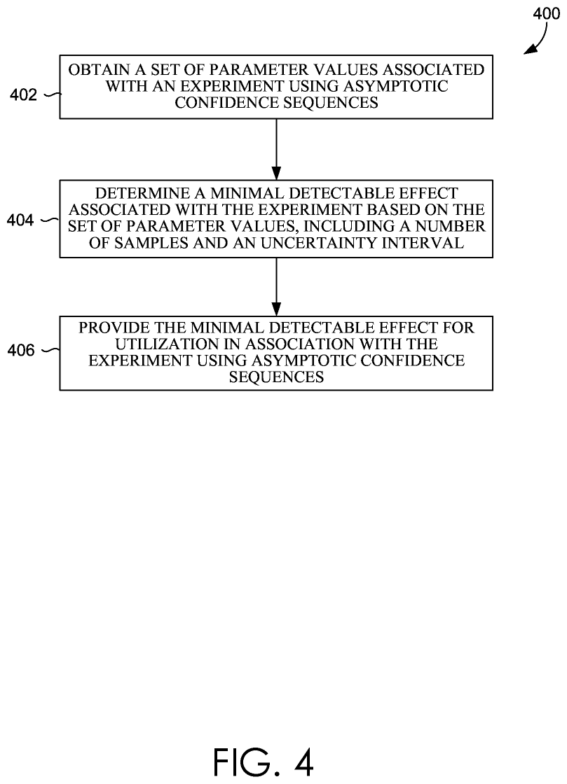

Turning to FIG. 4, FIG. 4 provides another example method flow 400 for generating experiment metrics, in accordance with embodiments described herein. Initially, in method flow 400, at block 402, a set of parameter values associated with an experiment using asymptotic confidence sequences is obtained. The asymptotic confidence sequences can maintain a one minus type I guarantee during continuous monitoring of experiment outcomes. In embodiments, the set of parameter values includes a number of samples and an uncertainty interval. The number of samples may be provided by a user specifying a target number of samples for executing the experiment. In embodiments, the uncertainty interval uncertainty interval is determined using a quantile parameter value, a standard deviation parameter value, and an optimization parameter value. The optimization parameter value can be determined to optimize a boundary condition. The set of parameter values may include values for other parameters, such as an empirical mean, a null hypothesis mean, and a total number of samples.

At block 404, a minimal detectable effect associated with the experiment is determined based on the number of samples and the uncertainty interval. In embodiments, the minimal detectable effect is determined via an optimization problem using the number of samples, the uncertainty level, and a confidence sequence associated with a null hypothesis at a time. In some cases, a root finding procedure is used to solve for the optimization problem.

At block 406, the minimal detectable effect is provided for utilization in association with the experiment using asymptotic confidence sequences. In one embodiment, providing the minimal detectable effect for utilization includes causing display of the minimal detectable effect via a user interface.

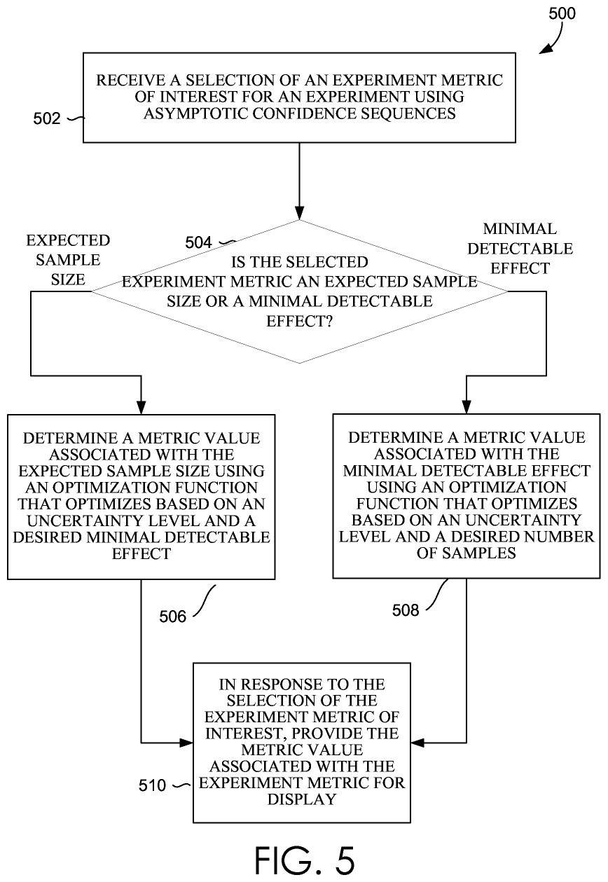

With reference to FIG. 5, FIG. 5 provides another example method flow 500 for generating experiment metrics, in accordance with embodiments described herein. Initially, at block 502, a selection of an experiment metric of interest for an experiment using asymptotic confidence sequences is received. For example, from among a set of experiment metrics presented via a user interface, a user may select a particular experiment metric of interest (e.g., an expected sample size and/or minimal detectable effect). At block 504, a determination is made as to whether the selected experiment metric comprises an expected sample size for the experiment or a minimal detectable effect. In cases in which the selected experiment metric is an expected sample size, a metric value associated with the expected sample size is determined using an optimization function that optimizes based on an uncertainty level and a desired minimal detectable effect, as indicated at block 506. Such a desired minimal detectable effect may be input via a user interface. On the other hand, in cases in which the selected experiment metric is a minimal detectable effect, a metric value associated with the minimal detectable effect is determined using an optimization function that optimizes based on the uncertainty level and a desired number of samples, as indicated at block 508. Such a desired number of samples may be input via a user interface. In embodiments, the metric value is determined using a root finding procedure to solve the optimization function. At block 510, in response to the selection of the experiment metric of interest, the metric value associated with the experiment metric of interest is provided for display.

Having described embodiments of the present invention, an example operating environment in which embodiments of the present invention may be implemented is described below in order to provide a general context for various aspects of the present invention. Referring to FIG. 6, an illustrative operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a smartphone or other handheld device. Generally, program modules, or engines, including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialized computing devices, etc. Embodiments of the invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output ports 618, input/output components 620, and an illustrative power supply 622. Bus 610 represents what may be one or more busses (such as an address bus, data bus, or combination thereof). Although the various blocks of FIG. 6 are shown with clearly delineated lines for the sake of clarity, in reality, such delineations are not so clear and these lines may overlap. For example, one may consider a presentation component such as a display device to be an I/O component, as well. Also, processors generally have memory in the form of cache. We recognize that such is the nature of the art, and reiterate that the diagram of FIG. 6 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. As depicted, memory 612 includes instructions 624. Instructions 624, when executed by processor(s) 614 are configured to cause the computing device to perform any of the operations described herein, in reference to the above discussed figures, or to implement any program modules described herein. The memory may be removable, non-removable, or a combination thereof. Illustrative hardware devices include solid-state memory, hard drives, optical-disc drives, etc. Computing device 600 includes one or more processors that read data from various entities such as memory 612 or I/O components 920. Presentation component(s) 616 present data indications to a user or other device. Illustrative presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. One or more computer-readable storage media having instructions stored thereon, which, when executed by one or more processors, cause the one or more processors to perform operations comprising:
obtaining a set of parameter values associated with an experiment using asymptotic confidence sequences, the set of parameter values including a minimal detectable effect and an uncertainty interval;
determining an expected sample size for executing the experiment based on the minimal detectable effect and the uncertainty interval; and
providing the expected sample size for utilization in association with the experiment using asymptotic confidence sequences.

2. The one or more computer-readable storage media of claim 1, wherein the set of parameter values further includes an empirical mean, a null hypothesis mean, and a total number of samples.

3. The one or more computer-readable media of claim 1, wherein the minimal detectable effect represents a smallest effect size that the experiment can detect with a certain probability and significance level.

4. The one or more computer-readable storage media of claim 1, wherein the minimal detectable effect is obtained based on a user input specifying the minimal detectable effect.

5. The one or more computer-readable storage media of claim 1, wherein the uncertainty interval is determined using a quantile parameter value, a standard deviation parameter value, and an optimization parameter value.

6. The one or more computer-readable storage media of claim 5, wherein the optimization parameter value is determined to optimize a boundary condition.

7. The one or more computer-readable storage media of claim 1, wherein the expected sample size is determined via an optimization problem using the minimal detectable effect, the uncertainty level, and a confidence sequence associated with a null hypothesis at a time.

8. The one or more computer-readable media of claim 1, wherein the expected sample size is determined using a root finding procedure to solve for an optimization problem.

9. The one or more computer-readable media of claim 1, wherein providing the expected sample size for utilization comprises causing display of the expected sample size via a user interface.

10. The one or more computer-readable media of claim 1, wherein providing the expected sample size for utilization comprises employing the expected sample size in conducting the experiment.

11. The one or more computer-readable media of claim 1, wherein the asymptotic confidence sequences maintains a one minus type I guarantee during continuous monitoring of experiment outcomes.

12. A computer-implemented method comprising:
obtaining, via a parameter value obtainer, a set of parameter values associated with an experiment using asymptotic confidence sequences, the set of parameter values including a number of samples and an uncertainty interval;
determining, via a minimal detectable effect generator, a minimal detectable effect associated with the experiment based on the number of samples and the uncertainty interval; and
providing, via a metric provider, the minimal detectable effect for utilization in association with the experiment using asymptotic confidence sequences.

13. The computer-implemented method of claim 12, wherein the number of samples is provided by a user specifying a target number of samples for executing the experiment.

14. The computer-implemented method of claim 12, wherein the uncertainty interval is determined using a quantile parameter value, a standard deviation parameter value, and an optimization parameter value.

15. The computer-implemented method of claim 12, wherein the minimal detectable effect is determined via an optimization problem using the number of samples, the uncertainty level, and a confidence sequence associated with a null hypothesis at a time.

16. The computer-implemented method of claim 12, wherein providing the minimal detectable effect comprises causing display of the minimal detectable effect via a user interface.

17. A computing system comprising:
one or more processors; and
one or more computer readable storage media, coupled with the one or more processors, having instructions stored thereon, which, when executed by the one or more processors cause the one or more processors to perform operations comprising:
receiving a selection of an experiment metric of interest for an experiment using asymptotic confidence sequences;
determining a metric value associated with the experiment metric of interest using an optimization function that optimizes for the experiment metric, wherein
an uncertainty level and a desired minimal detectable effect is used to determine an expected sample size for the experiment, and
the uncertainty level and a desired number of samples is used to determine a minimal detectable effect associated with the experiment; and
in response to the selection of the experiment metric of interest, causing display of the metric value associated with the experiment metric of interest.

18. The computing system of claim 17, wherein the selection of the experiment metric of interest is received based on a user selection, via a user interface, from among a set of experiment metrics.

19. The computing system of claim 17, wherein the metric value is determined using a root finding procedure to solve the optimization function.

20. The computing system of claim 17, wherein the desired minimal detectable effect and the desired number of samples are input via a user interface.
